(19) United States
(12) Patent Application Publication
(10) Pub. No.: US 2025/0192708 A1
(43) Pub. Date: Jun. 12, 2025

(54) INDUCTION MOTOR TORQUE ESTIMATION METHOD

(71) Applicant: EATON INTELLIGENT POWER LIMITED, Dublin 4 (IE)

(72) Inventors: Gurmeet SINGH, Maharashtra (IN); Sneha ABHYANKAR, Pune (IN)

(21) Appl. No.: 18/844,495

(22) PCT Filed: May 6, 2022
(86) PCT No.: PCT/EP2022/025207

§ 371 Date: Sep. 6, 2024

(30) Foreign Application Priority Data
Mar. 9, 2022 (IN) 202211012812

(51) Int. Cl. H02P 23/26; H02P 23/14

(52) U.S. Cl. CPC H02P 23/26; H02P 23/14; H02P 2207/01

(57) ABSTRACT

Some embodiments relate to a method of estimating induction motor torque. The method can include calculation of the ratio of output power (P₀₁) to motor rotational speed (N₁). The calculation includes determining, using motor name plate information (NPI), rated motor information; measuring motor operational parameters, the parameters including rotational speed (N₁), root mean squared, RMS, current (I₁), input power (Pᵢ₁) and supply frequency (f₁); calculating rated motor power losses; calculating total motor operational power losses (Pₗₒₛₛ₁) from a combination of individual motor operational power losses; determining output power (Pₒ₁) from the measured input power (Pᵢ₁) and the total motor operational power loss (Pₗₒₛₛ₁). The induction motor torque (T₁) is calculated using the ratio of output power (P₀₁) to motor rotational speed (N₁).

### CROSS-REFERENCE TO RELATED APPLICATIONS

This application is a national phase filing under 35 C.F.R. § 371 of and claims priority to PCT Patent Application No. PCT/EP2022/025207, filed on May 6, 2022, which claims the priority benefit under 35 U.S.C. § 119 of European Patent Application No. 202211012812, filed on Mar. 9, 2022, the contents of which are hereby incorporated in their entireties by reference.

### FIELD OF THE DISCLOSURE

The presently disclosed subject matter relates to a method of estimating induction motor torque.

### BACKGROUND TO THE DISCLOSURE

The determination of induction motor torque is essential for estimating the motor load condition in control and fault diagnosis applications. Additionally, motor torque can also be used to approximate the motor efficiency of an induction motor, and to estimate the load side parameters like in-pump optimization, where an accurate value of the torque is useful for estimating the pump's head and flow.

It is known to measure torque directly by using torque sensors. Although this method is accurate, the cost of a torque sensor is very high, and it requires frequent maintenance. Therefore, this approach can't be used in industry for all motors.

Lu, B., Habetler et al. titled: “A nonintrusive and in-service motor-efficiency estimation method using air-gap torque with considerations of condition monitoring”, IEEE transactions on Industry Applications, 44(6), pp. 1666-1674 discloses that torque can be estimated indirectly by using an air gap torque estimation method. The air gap torque estimation method uses an estimation of winding resistance using an additional hardware for a DC current injection circuit. The method uses the instantaneous values of the three phase voltages and current, thereby also requiring sensors which also increases costs.

Therefore, there is a need for an indirect method of determining motor torque which are sensor-less, easy to implement and which can provide reliable results.

### SUMMARY OF THE DISCLOSURE

According to a first aspect of the presently disclosed subject matter, there is provided a method of estimating induction motor torque, the method comprising a calculation of the ratio of output power to motor rotational speed, wherein the calculation comprises: determining, using motor name plate information (NPI), rated motor information; wherein the rated motor information comprises at least a rated motor output power; measuring motor operational parameters, the parameters comprising motor rotational speed, root mean squared, RMS, current, input power and supply frequency; calculating rated motor power losses; calculating total motor operational power losses (Pₗₒₛₛ₁) from a combination of individual motor operational power losses, wherein the individual motor operational power losses are further calculated based on the measured rated motor information, the measured motor operational parameters and the calculated rated motor power losses; determining output power from the measured input power and the total motor operational power loss; and wherein the induction motor torque is calculated using the ratio of output power to motor rotational speed. Advantageously, this aspect provides an indirect method of estimating induction motor torque which has reduced cost compared to a system requiring a sensor, which provides an accurate and reliable estimation of said torque, and which is easy to implement.

Preferably, the rated motor information further comprises rated motor rotational speed, rated efficiency, rated supply frequency and rated current.

Preferably, the individual motor operational power losses include stator copper power loss, stator stray power loss, rotor stray power loss, rotor copper power loss and friction and wind-related power losses.

Preferably, the rated motor information is determined using a table or a database.

Preferably, the calculating of the rated motor power losses comprises:
for rated stator copper power loss: P_{scl_r}=(−A*P_{o_r})+A1,
where A=−0.4 to 0.4 and A1=30 to 80;
for rated core power loss: P_{cl1_r}=(B*P_{o_r})+B1,
where B=−0.2 to 0.2 and B1=5 to 35;
for rated rotor copper power loss: P_{rcl1_r}=(C*P_{o_r})+C1,
where C=−0.2 to 0.2 and C1=0 to 35;
for rated stray power loss: P_{sl1_r}=(D*P_{o_r})+D1,
where D=−0.2 to 0.2 and D1=0 to 20; and
for rated friction and wind-related power losses: P_{fw1}_{ᵣ}=(E*Pₒ_{ᵣ})+E1,
where E=−0.2 to 0.2 and E1=0 to 20.

Preferably, the calculating of the individual motor operational power losses comprises:
for stator copper power:

$${P}_{scl 1} = ( \frac{{{I}_{1}}^{2}}{{{I}_{1 \_ r}}^{2}} ) ;$$

for core power loss:

$${P}_{cl 1} = ( {( \frac{{f}_{1}}{{f}_{1 \_ r}} )}^{2} {aP}_{cl 1 \_ r} ) + ( ( \frac{{f}_{1}}{{f}_{1 \_ r}} ) {bP}_{cl 1 \_ r} ) ,$$

where a=0 to 1 and b=0 to 1, such that a+b=1, and preferably a=0.3 and b=0.7;
for rotor copper power loss:

$${P}_{rcl 1} = ( \frac{{{I}_{1}}^{2}}{{{I}_{r}}^{2}} ) {P}_{{rcl}_{r}} ;$$

for stray power loss: Pₛₗ₁˜P_{sl1_r}; and for friction and wind-related power losses:

$${P}_{fw 1} = ( \frac{{{N}_{1}}^{2}}{{{N}_{1 \_ r}}^{2}} ) {P}_{fw 1 \_ r} .$$

Preferably, the determining of the output power comprises taking the difference between the measured input power and the total motor operational power loss.

Preferably, the calculating of induction motor torque comprises:

$${T}_{1} = \frac{{P}_{o 1} * 60}{2 π {N}_{1}} .$$

According to a second aspect of the presently disclosed subject matter, there is provided a non-transitory computer readable storage medium for storing instructions to perform the method of the first aspect of the presently disclosed subject matter.

### DETAILED DESCRIPTION OF DRAWINGS

Embodiments of the presently disclosed subject matter will now be described by way of example only and with reference to the accompanying drawings, in which:

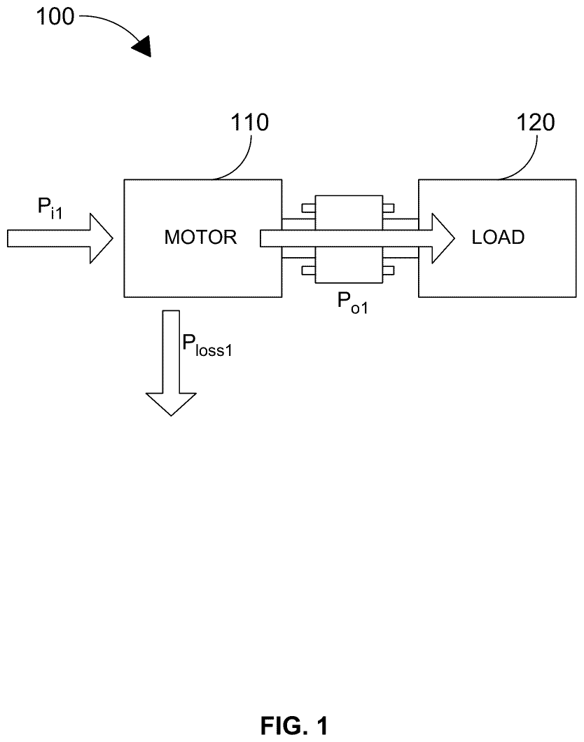

FIG. 1 depicts a schematic of a system 100 for transferring power;

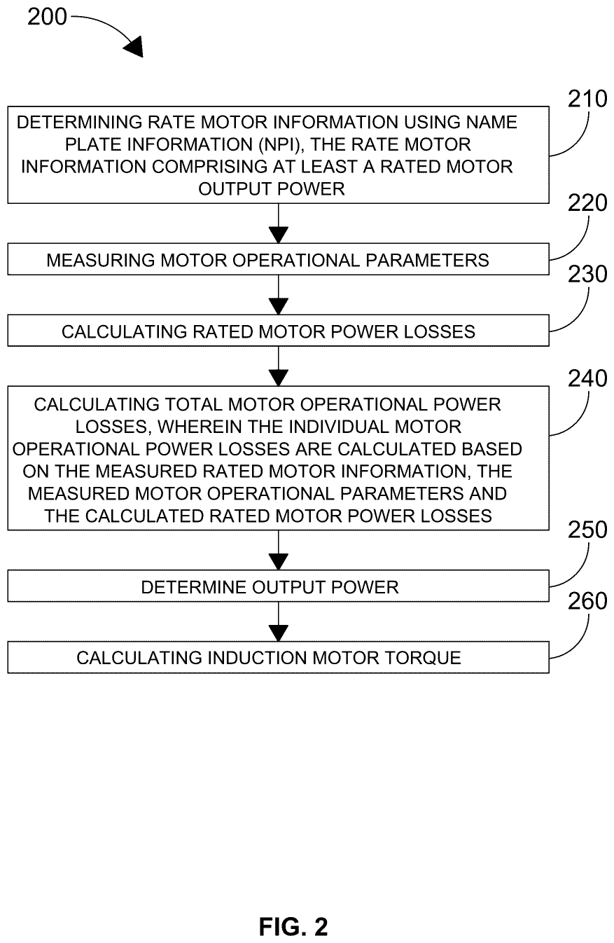

FIG. 2 depicts a method 200 of estimating induction motor torque in accordance with a first aspect of the present claimed presently disclosed subject matter;

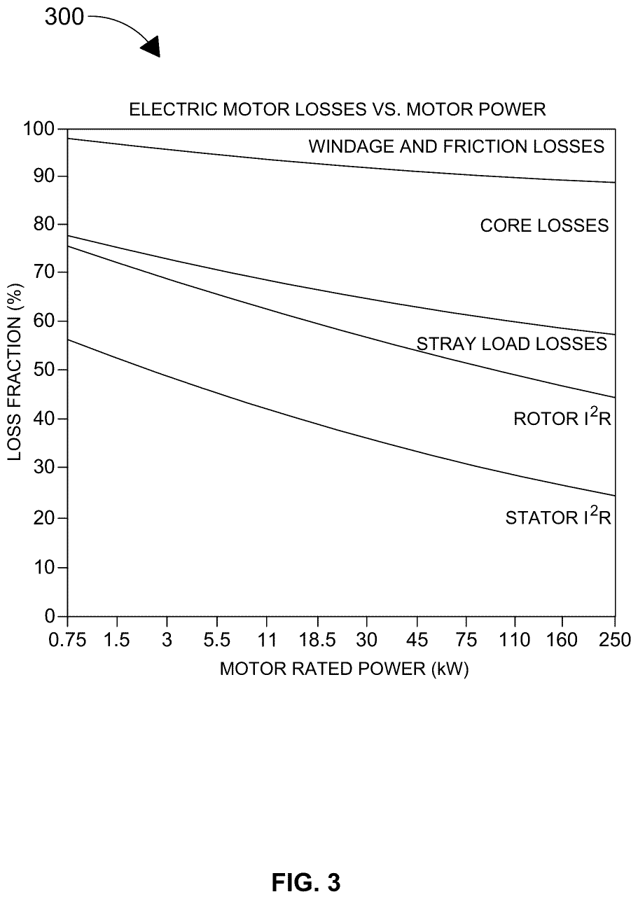

FIG. 3 depicts an empirically derived graph 300 of power loss fraction % as a function of motor rated power, which is used to estimate individual motor operational power losses;

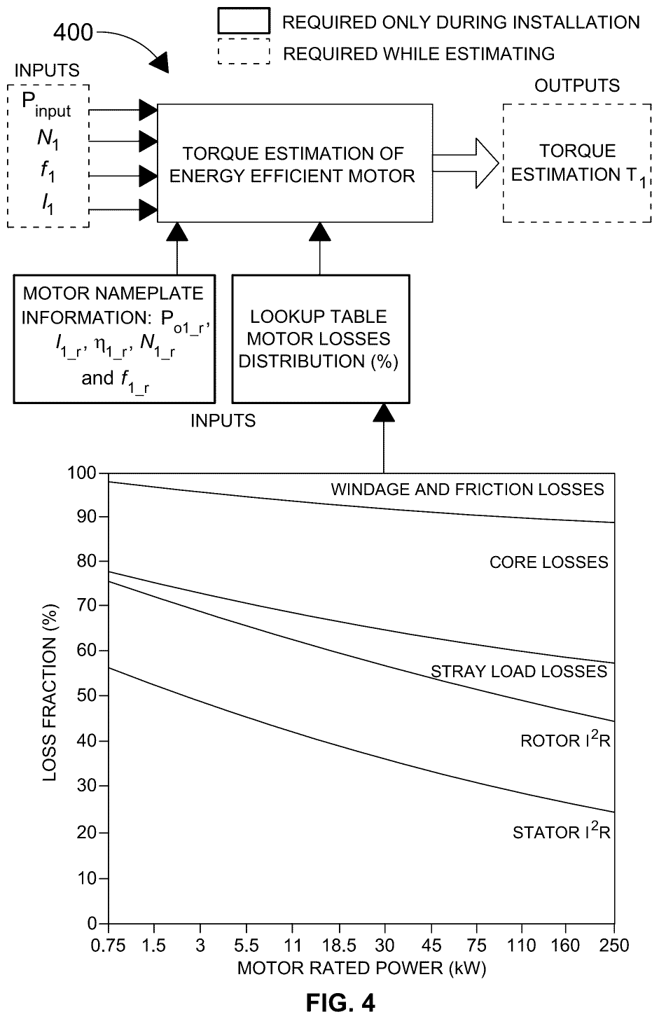

FIG. 4 depicts a schematic 400 of the overall method of estimating induction motor torque in accordance with the first aspect of the present claimed presently disclosed subject matter;

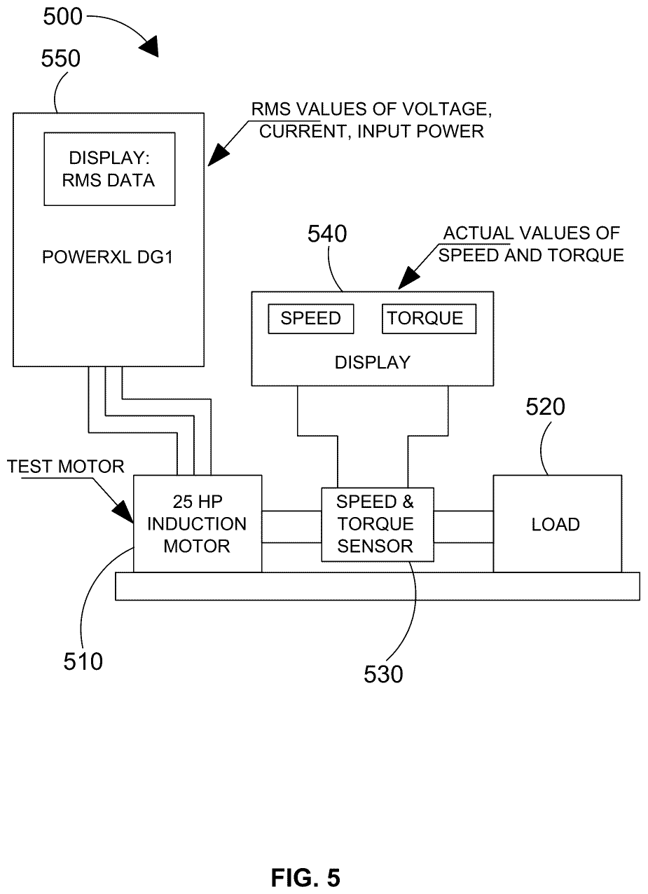

FIG. 5 depicts a schematic 500 of an experimental set-up used to test the accuracy of the method of estimating induction motor torque in accordance with the first aspect of the present claimed presently disclosed subject matter;

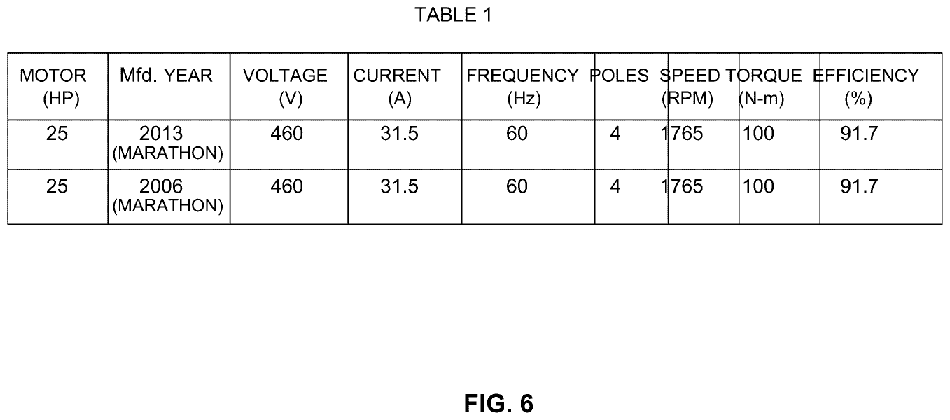

FIG. 6 depicts a table of NPI information for two test induction motors;

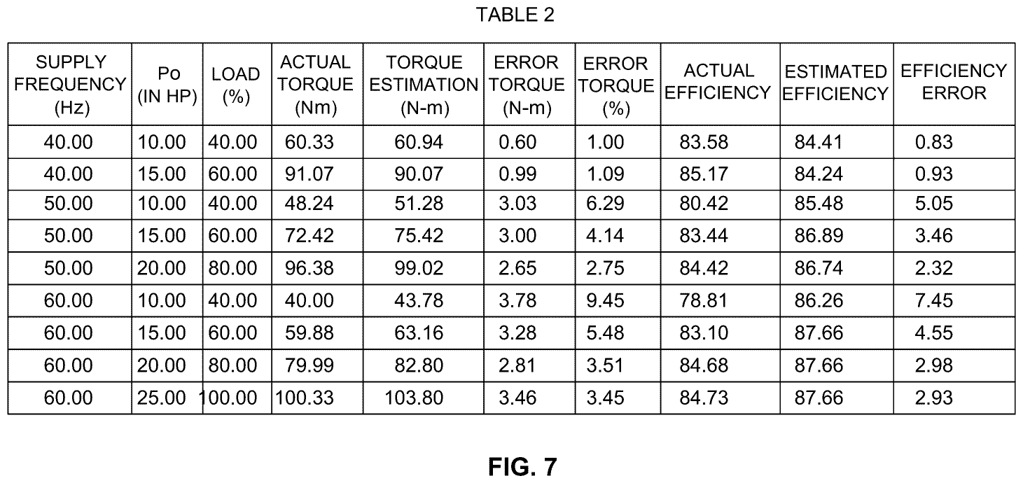

FIG. 7 depicts the results of tests for a 2013 induction motor; and

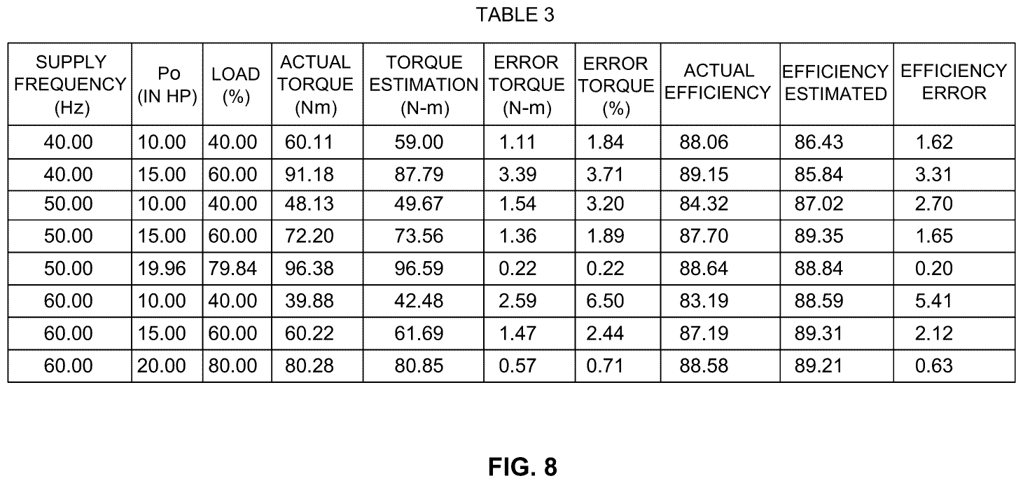

FIG. 8 depicts the results of tests for a 2006 induction motor.

With reference to FIG. 1, this depicts a schematic of a system 100 for transferring power, such as in an electrical vehicle. The system 100 of FIG. 1 comprises an induction motor 110 which converts an input power (Pᵢ₁) and produces an output power (Pₒ₁) to drive a mechanical load 120. In generating the output power (Pₒ₁), the induction motor 110 experiences total motor operational power losses (Pₗₒₛₛ₁) due to a number of types of individual motor operational power losses.

With reference to FIG. 2, a method 200 of estimating induction motor torque is depicted. The method 200 comprises determining 210, using motor name plate information (NPI), rated motor information. The rated motor information are values recorded for a specific model of induction motor engine manufactured at a specific time. The NPI is information which is found by using an electrical vehicles nameplate (i.e. its license plate or another identification number/code which identifies the vehicle or an induction motor engine) and which allows the determination of rated information of a particular vehicle. The rated motor information comprises at least a rated motor output power (Pₒₗᵣ).

The method 200 further comprises measuring 220 motor operational parameters, the motor operational parameters comprising motor rotational speed (N₁), root mean squared, RMS, current (I₁), input power (Pᵢ₁) and supply frequency (f₁).

The method 200 further comprises calculating 230 rated motor power losses; and calculating 240 total motor operational power losses (Pₗₒₛₛ₁) from a combination of individual motor operational power losses. The individual motor operational power losses are further calculated based on the measured rated motor information, the measured motor operational parameters and the calculated rated motor power losses. The method 200 further comprises determining 250 output power (Pₒ₁) from the measured input power (Pᵢ₁) and the total motor operational power loss (Pₗₒₛₛ₁); and calculating 260 induction motor torque (T₁) using the ratio of output power (P₀₁) to motor rotational speed (N₁).

With reference to FIG. 3, this depicts a known empirically determined graph of power loss fraction percentage as a function of rated motor output power (Pₒₗᵣ) which depicts the individual motor operational power losses. The individual motor operational power losses comprise stator power losses, rotor power losses, stray load power losses, core power losses and windage (i.e. wind-related) and friction power losses. The stator power loss and rotor power loss are the resistance to the flow of current in the rotor and stator of the induction motor, respectively. The stray load losses are additional load losses. The core power losses are losses from magnetic field leakage. The windage and friction power losses are power losses related to overcoming friction in the mechanical bearings and in overcoming air resistance to the rotor and fan of the induction motor.

With reference to FIG. 4, this depicts a schematic illustration of the method of estimating induction motor torque. The method involves using measured motor operational parameters as an input, the parameters comprising motor rotational speed (N₁), root mean squared, RMS, current (I₁), input power (Pᵢ₁) and supply frequency (f₁).

Additionally, the method involves using induction motor nameplate information as a further input, the nameplate information being used to determine rated motor information, wherein the rated motor information comprises at least a rated motor output power (Pₒₗᵣ). The nameplate information may further include rated motor rotational speed (N₁ᵣ), rated efficiency (ηᵣ), rated supply frequency (f₁ᵣ) and rated current (I₁ᵣ). Furthermore, the method involves using the results depicted in FIG. 3 in order to determine the rated motor power losses. FIG. 4 depicts that the output of the method as an estimation of the induction motor torque (T₁). FIG. 4 further depicts which inputs are required during installation of the induction motor and which inputs are required when calculating the induction motor torque.

With reference to FIG. 5, this depicts an experimental system 500 used to determine the accuracy of the method of calculating induction motor torque, as described in FIG. 2.

In system 500, a 25 horse power (HP) induction motor 510 was used to drive a mechanical load 520. The system 500 had a speed sensor and a torque sensor 530 used to determine the speed and torque output from the induction motor 510. The determined speed and torque outputs were then displayed on a display 540. The system 500 further comprises a motor operational parameters unit used to measure the motor operational parameters from the induction motor 510.

In the experimental set up depicted in FIG. 5, two test induction motors were measured. The NPI information for these two test induction motors is seen in Table 1, as depicted in FIG. 6. Table 1 shows the NPI for two 25 HP induction motors, including their manufacturing year (i.e. 2013 and 2006), and their motor rated information, including their rated voltage and rated current (which is used to determine the rated power), and their rated frequency, rated speed, rated torque and rated efficiency.

The results of these tests are seen in Table 2, as depicted in FIG. 7, for the 2013 induction motor of Table 1; and in Table 3, as depicted in FIG. 8, for the 2006 induction motor of Table 1.

It will be appreciated that the above described embodiments of the first and second aspects of the presently disclosed subject matter are given by way of example only, and that various modifications may be made to the embodiments without departing from the scope of the presently disclosed subject matter as defined in the appended claims.

For example, in use the system 100 of FIG. 1 may optionally be a system 100 of an electrical vehicle. Furthermore, the induction motor 110 may receive input power from a power source, such as a battery, in order to receive the energy required to drive the mechanical load 120.

The rated motor information of FIG. 2 may further comprise rated motor rotational speed (N₁ᵣ), rated efficiency (ηᵣ), rated supply frequency (f₁ᵣ) and rated current (I₁ᵣ). In use, the rated motor information may be determined using a table or a database which stores the rated motor information. The method 200 comprises calculating 230 rated motor power losses. In use, this is achieved using Equations 1-5 for the rated stator copper power loss (P_{scl_r}), the rated core power loss (P_{el1_r}), the rated rotor copper power loss (P_{rcl_r}), the stray power loss (P_{sl1_r}) and the friction and windage power loss (P_{fw1_r}), respectively:

$${P}_{scl \_ r} = ( - A * {P}_{o \_ r} ) + A 1 , \qquad Equation 1$$

$$Where A = - 0.4 to 0.4 and A 1 = 30 + 80 ;$$

$${P}_{cl 1 \_ r} = ( B * {P}_{o \_ r} ) + B 1 , \qquad Equation 2$$

$$Where B = - 0.2 to 0.2 and B 1 = 5 + 35 ;$$

$${P}_{rcl 1 \_ r} = ( C * {P}_{o \_ r} ) + C 1 , \qquad Equation 3$$

$$Where C = - 0.2 to 0.2 and C 1 = 0 + 35 ;$$

$${P}_{sl 1 \_ r} = ( D * {P}_{o \_ r} ) + D 1 , \qquad Equation 4$$

$$Where D = - 0.2 to 0.2 and D 1 = 0 + 20 ; and$$

$${P}_{fw {1}_{r}} = ( E * {P}_{{o}_{r}} ) + E 1 , \qquad Equation 5$$

$$where E = - 0.2 to 0.2 and E 1 = 0 to 20.$$

P_{o_r} in Equations 1-5 is the rated output power.

Furthermore, in relation to FIG. 2, the calculating 240 of total motor operational power losses (Pₗₒₛₛ₁) may be determined by taking the summation of the individual motor operational power losses. The individual motor operational power losses may be determined using Equations 6-10.

$${P}_{scl 1} = ( \frac{{{I}_{1}}^{2}}{{{I}_{1 \_ r}}^{2}} ) ; \qquad Equation 6$$

$${P}_{cl 1} = ( {( \frac{{f}_{1}}{{f}_{1 \_r}} )}^{2} {aP}_{cl 1 \_ r} ) + ( ( \frac{{f}_{1}}{{f}_{1 \_r}} ) {bP}_{cl 1 \_ r} ) , \qquad Equation 7$$

$$where a = 0 to 1 and b = 0 to 1 , such that a + b = 1 , and preferably a = 0.3 and b = 0.7 ;$$

$${P}_{rcl 1} = ( \frac{{{I}_{1}}^{2}}{{{I}_{1 \_ r}}^{2}} ) {P}_{{rcl}_{r}} \qquad Equation 8$$

$${P}_{sl 1} \sim {P}_{sl 1 \_ r} \qquad Equation 9$$

$${P}_{fw 1} = ( \frac{{{N}_{1}}^{2}}{{{N}_{1 \_ r}}^{2}} ) {P}_{fw 1 \_ r} \qquad Equation 10$$

In Equations 6-10, P_{scl1} is the calculated stator copper power loss, P_{cl1} is the calculated core power loss, P_{rcl1} is the calculated rotor copper power loss, Pₛₗ₁ is the calculated stray power loss and P_{fw1} is the calculated friction and windage power loss. I_{1_r}, f_{1_r} and N_{1_r} are the rated current, rated frequency and rated speed of the induction motor. P_{scl_r}, P_{cl1_r}, P_{rcl_r}, P_{sl1_r} and P_{fw1_r} are the same as is described in relation to Equations 1-5.

Furthermore, the determining 250 of the output power (P₀₁) may comprise taking the difference between the measured input power and the total motor operational power loss. The induction motor torque (T₁) may be calculated 250 using said determined output power, using Equation 11:

$${T}_{1} = \frac{{P}_{o 1} * 60}{2 π {N}_{1}} \qquad Equation 11$$

1. A method of estimating induction motor torque, comprising a calculation of the ratio of output power to motor rotational speed, wherein the calculation comprises:
determining, using motor name plate information, rated motor information; wherein the rated motor information comprises at least a rated motor output power;
measuring motor operational parameters, the parameters comprising motor rotational speed, root mean squared, RMS, current, input power and supply frequency calculating rated motor power losses;
calculating total motor operational power losses (Ploss1) from a combination of individual motor operational power losses, wherein the individual motor operational power losses are further calculated based on the measured rated motor information, the measured motor operational parameters and the calculated rated motor power losses;
determining output power from the measured input power and the total motor operational power loss; and
wherein the induction motor torque is calculated using the ratio of output power to motor rotational speed.

2. The method of claim 1, wherein the rated motor information further comprises rated motor rotational speed, rated efficiency, rated supply frequency and rated current.

3. The method of claim 1, wherein the individual motor operational power losses include stator copper power loss, stator stray power loss, rotor stray power loss, rotor copper power loss and friction and wind-related power losses.

4. The method of claim 1, wherein the rated motor information is determined using a table or a database.

5. The method of claim 1, wherein the calculating of the rated motor power losses comprises:
for rated stator copper power loss: P_{scl_r}=(−A*P_{o_r})+A1,
where A=−0.4 to 0.4 and A1=30 to 80;
for rated core power loss: P_{cl1_r}=(B*P_{o_r})+B1,
where B=−0.2 to 0.2 and B1=5 to 35;
for rated rotor copper power loss: P_{rcl1_r}=(C*P_{o_r})+C1,
where C=−0.2 to 0.2 and C1=0 to 35;
for rated stray power loss: P_{sl1_r}=(D*P_{o_r})+D1,
where D=−0.2 to 0.2 and D1=0 to 20; and
for rated friction and wind-related power losses: P_{fw1}_{ᵣ}=(E*Pₒ_{ᵣ})+E1,
where E=−0.2 to 0.2 and E1=0 to 20.

6. The method of claim 1, wherein the calculating of the individual motor operational power losses comprises:
for stator copper power:
$${P}_{scl 1} = ( \frac{{{I}_{1}}^{2}}{{{I}_{1 \_ r}}^{2}} ) ;$$
for core power loss:
$${P}_{cl 1} = ( {( \frac{{f}_{1}}{{f}_{1 \_ r}} )}^{2} {aP}_{cl 1 \_ r} ) + ( ( \frac{{f}_{1}}{{f}_{1 \_ r}} ) {bP}_{cl 1 \_ r} ) ,$$
where a=0 to 1 and b=0 to 1, such that a+b=1, and preferably a=0.3 and b=0.7;
for rotor copper power loss:
$${P}_{rcl 1} = ( \frac{{{I}_{1}}^{2}}{{{I}_{r}}^{2}} ) {P}_{{rcl}_{r}} ;$$
for stray power loss: Pₛₗ₁˜P_{sl1_r}; and
for friction and wind-related power losses:
$${P}_{fw 1} = ( \frac{{{N}_{1}}^{2}}{{{N}_{1 \_ r}}^{2}} ) {P}_{fw 1 \_ r} .$$

7. The method of claim 1, wherein the determining of the output power comprises taking the difference between the measured input power and the total motor operational power loss.

8. The method of claim 1, wherein the calculating of induction motor torque comprises:
$${T}_{1} = \frac{{P}_{o 1} * 60}{2 π {N}_{1}} .$$

9. A non-transitory computer readable storage medium for storing instructions to perform the method of claim 1.
